(19) United States
(12) Patent Application Publication
(10) Pub. No.: US 2026/0350619 A1
(43) Pub. Date: Nov. 5, 2026

(54) SCAM DETECTION BASED ON PERSONALLY IDENTIFIABLE INFORMATION

(71) Applicant: MASTERCARD INTERNATIONAL INCORPORATED, Purchase, NY (US)

(72) Inventors: Neha SHARMA, Bothell, WA (US); Adrienn JUHASZ, Budapest (HU)

(73) Assignee: MASTERCARD INTERNATIONAL INCORPORATED, Purchase, NY (US)

(21) Appl. No.: 19/198,954

(22) Filed: May 5, 2025

(51) Int. Cl. G06Q 20/40; G06Q 20/10

(52) U.S. Cl. CPC G06Q 20/4016; G06Q 20/108

(57) ABSTRACT

The disclosure relates to methods and systems of detecting scams for account-to-account (A2A) transfers. For example, a system may receive a transfer record for an A2A transaction. The system may expand signals from the transfer record to generate an expansion signal set. The system may generate a plurality of features based on the expansion signal set. The system may execute the trust classification model with the plurality of features, the trust classification model having been trained to generate a prediction of whether the A2A transfer is associated with a scam by the receiver on the sender. The system may generate a classification output based on the executed trust classification model, the classification output representing a probability that the A2A transfer is a scam. The system may transmit the classification output to the sender device. The classification output is used to determine a responsive action for the A2A transfer.

### BACKGROUND

In today's digital landscape, the convenience of digital payments has revolutionized financial transactions, allowing users to transfer funds using minimal information, such as a phone number or email address, almost instantaneously. However, this ease of use has also facilitated a rise in scams, particularly within peer-to-peer (P2P) payment systems and other account-to-account (A2A) payment systems. These platforms often enable real-time, irreversible transactions.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a data flow in an A2A transfer;

FIG. 2 illustrates an example of a system environment of training, re-training, and activating machine learning models for detecting scams in A2A transfers;

FIG. 3 illustrates a data flow of an example of signal expansion, feature selection, and training the trust classification model in the system environment;

FIG. 4 illustrates a data flow of an example of signal expansion and feature selection for classifying an A2A transfer based on the trained trust classifier model;

FIG. 5 illustrates an example of a data flow of an A2A transfer with injected code for trust classification to detect scam transfers for termination;

FIG. 6 illustrates an example of a method for classifying an A2A transfer and terminating the transaction if classified as a scam;

FIG. 7 illustrates another example of a method for classifying an A2A transfer and terminating the transaction if classified as a scam; and

FIG. 8 illustrates an example of a computer system that may be implemented by devices illustrated in FIGS. 1-5.

### DETAILED DESCRIPTION

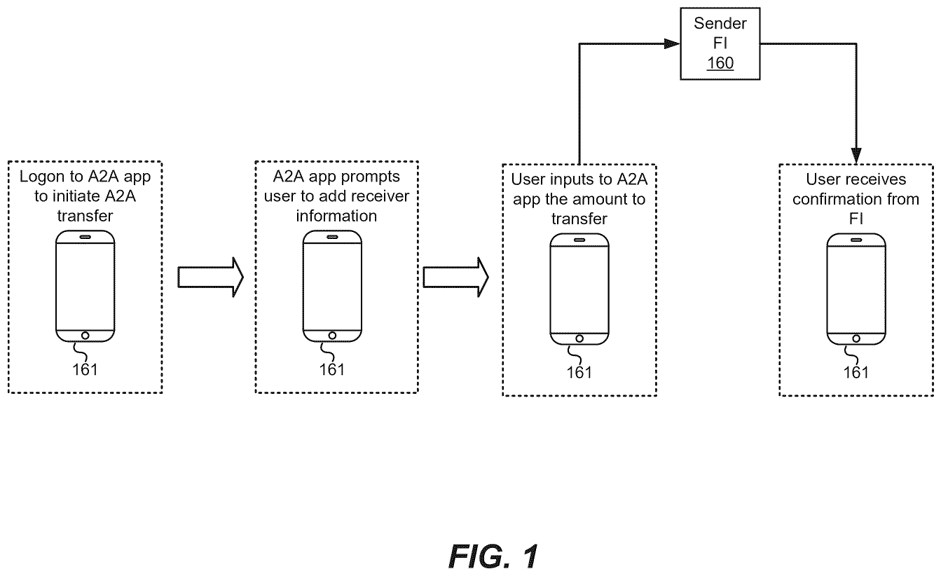

The disclosure relates to methods and systems of detecting scams in A2A transfers. The system facilitates seamless scam checking even if the sender intends to make the A2A transfer to the receiver. FIG. 1 illustrates an example of processing flow in an A2A transfer from a sender to a receiver. The receiver may ask a sender to transfer funds via an A2A transfer. The request may be legitimate or could be a scam. In either instance, the sender trusts the receiver. The sender may use a sender device 161 (such as a mobile phone of the sender) to launch an A2A application 163, which may be provided by and communicate with a sender financial institution (FI) 160. The A2A application 163 may prompt the sender to input the receiver's information, such as information that identifies the receiver. The receiver information can be an email address, phone number, and/or other information that can identify the receiver. The A2A application 163 may prompt the sender to input a transfer amount.

The A2A application 163 may generate a transfer record 165 based on the receiver information, the transfer amount, and sender information. The sender information may include sender identifying data such as an account number, a name, a phone number, address, IP address, an email address, and/or other information that can identify the sender or sender's account at the sender FI 160. The A2A application 163 may transmit a transfer request to the sender FI 160. The transfer request may include the transfer record 165. The sender FI 160 may confirm there are sufficient funds and then transfer the funds from the sender's account to the receiver's account at a receiver FI, and then send a confirmation of the transfer to the A2A application 163.

While an intermediate platform, such as a peer-to-peer (P2P) platform is not shown, the operations may be similar, except that the P2P platform may mediate the transfer between the sender FI 160 and the receiver FI via the A2A application 163, which may be provided by the P2P platform. The term “A2A” as used herein is intended to include P2P transfers unless explicitly noted otherwise.

Original Signal Data from A2A Records

In some examples, during the course of processing the A2A transfer, information about the A2A transfer, sender and/or receiver may be received or otherwise collected. For example, the sender FI 160, the receiver FI, P2P platform (for P2P implementations), and/or other entity may collect the information about the A2A transfer. This collected data may include a transaction time stamp, a sender name, a sender phone, a sender email address, a sender IP address, a sender physical address, a sender bank (FI) account identifier, a receiver name, a receiver phone, a receiver email, a, a receiver physical address, a receiver bank account identifier, a receiver bank (FI) identifier, a transaction amount, a transaction note, and an outcome of the transfer (success, declined, reason).

A problem with A2A transfers is that, unlike other forms of fraud involving stolen identity, a sender may be scammed by a receiver into believing that a fund transfer is legitimate. These types of scams can be difficult to detect and mitigate because the sender intends to transfer funds to the receiver. Thus, traditional methods of detection and mitigation may fail because the sender will confirm the legitimacy of the transfer. Furthermore, the signals in a given A2A transfer, may be sparse. Simply put, there may not be enough information in an A2A transfer record to determine whether or not an A2A transfer is a scam.

To address these and other issues with A2A related scams, a system may use injection code in an A2A application to call into the system for sharing A2A transfer data. The injection code may interrupt the usual flow between the sender and the sender FI so that the system may inspect the A2A transfer data for AI-based scam detection. To address data sparseness in the A2A transfer data, the system may perform signal expansion in which sparse A2A transfer data is expanded into a plurality of signals for feature generation, vectorization, and AI-based scam classification.

Once signal expansion is performed and the expansion signal set is generated, the system may generate corresponding features for executing machine learning models to classify A2A transfers. The expansion signal set may include one or more identity verification signals, one or more relationship history signals, one or more network pattern signals, and/or other types of signals.

In generating the expansion signal set, the system may derive multiple signals from the available data input that enables scam detection based on signals related to identity verification of a sender and/or a receiver. For example, the system may determine their relationship and map their network activity pattern to identify any signs of past/potential fraudulent behavior and thus establish trust in the given transfer.

The system may use personal identity data elements on both sender and receiver to derive signals that can be indicative of potential scam in a transaction. The underlying logic of the solution is to find a) a relation/connection between the two transacting parties by understanding their past interaction history, transaction/activity pattern and location proximity to create a trust factor that can be used to detect potential scam, and/or b) the historical behavior of both the sender and receiver in relation to the other parties they have interacted with previously within the payment network, For example, if the sender is from Hungary, and the receiver is from the US, the system may determine whether the sender previously transferred funds from Hungary to the US or whether this transfer was the first time. In another example, the system may determine the average transfer amount the sender usually transfers compared to the current transfer amount.

The system may generate features based on the expansion signal set for training and/or execution. For example, the system may vectorize each signal from among the expansion signal set. The trust classification model may be trained based on an expansion signal set that is derived from the collected A2A transfer data and expansion data from one or more data sources. The one or more data sources may include third party data sources, data from payment network processing, and/or other sources. The expansion signal set from the training data may be vectorized into a plurality of candidate features. Feature selection may be performed on the candidate features to select relevant features for training the trust classification model against known outcomes from the collected A2A transfer data.

Once relevant features are selected, hyperparameters may be tuned, such as to mitigate against bias by adjusting the learning rate. Doing so may, for example, reduce overfitting or otherwise address data issues that can lead to bias. After feature selection and hyperparameter tuning, the machine learning models may be used to classify A2A transfers for scam detection and mitigation.

In an example operation, a sender may initiate, via an A2A application, an A2A transfer to a receiver. Injection code at the A2A application may, prior to initiating the transfer, transmit an A2A transfer record to the system. The system may perform signal expansion on the A2A transfer record, vectorize the expanded signals, and execute the trained model. The trust classification model may generate a trust classification output. The trust classification output may be a regression output that represents a probability that the A2A transfer is a scam. The system may map the trust classification output to an A2A classification, which in turn is mapped to a responsive action to take. Generally speaking, the responsive action may include an approval (low scam probability), a pending further review (moderate scam probability), and a rejection (high scam probability). Other numbers and/or types of categories of responsive actions may be used.

Having described an overview of examples of operation of detecting anomalies, attention will now turn to an example of a system environment in which the machine learning models are trained and used.

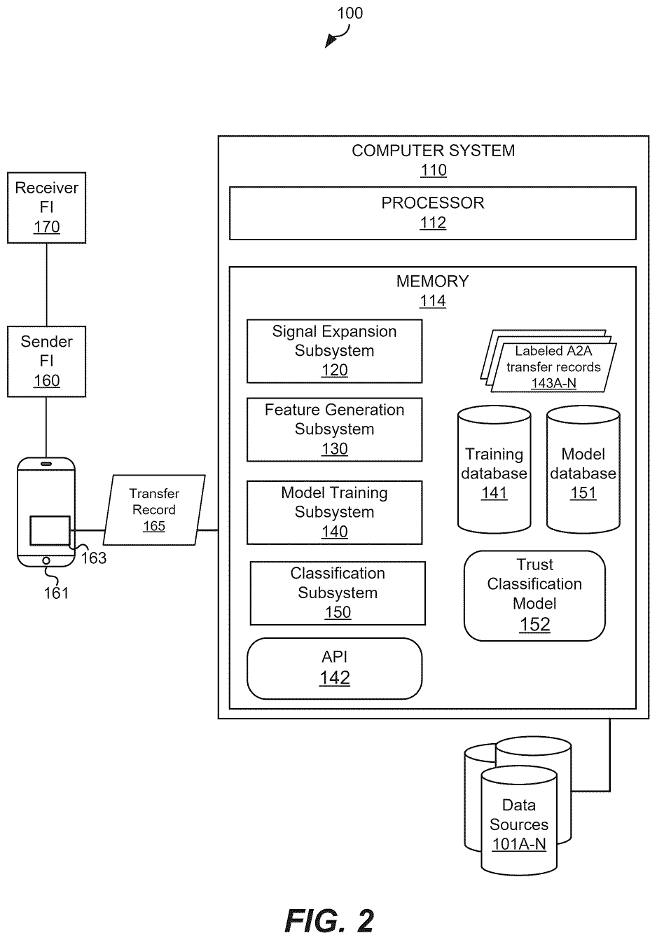

FIG. 2 illustrates an example of a system environment 100 of training, re-training, and activating machine learning models for detecting scams in A2A transfers. The system environment 100 may include one or more data sources 101A-N, a computer system 110, a sender device 161, a receiver financial institution (FI) 170, a sender FI 160, and/or other components. At least some of the components of the system environment 100 may be connected to one another via a communication network, which may include the Internet, an intranet, a Personal Area Network, a LAN (Local Area Network), a WAN (Wide Area Network), a SAN (Storage Area Network), a MAN (Metropolitan Area Network), a wireless network, a cellular communications network, a Public Switched Telephone Network, and/or other network through which system environment 100 components may communicate.

The data sources 101A-N may include data that is used to expand sparse signals to generate rich features for training and executing one or more trust classification models 152. For example, the data sources 101A-N may include data (referred to herein as “secondary data”) that is used, in combination with sparse signals from A2A transfer data, to generate new signals that are converted into features for training and executing a trust classification model 152. The data sources 101 may include trusted third party data sources, which may provide data about known entities among other relevant data, payment network data derived from information known about merchants or other entities, and/or other data sources that can augment sparse signals for scam detection.

The computer system 110 may include one or more computing devices for detecting potential scams in A2A transfers. For example, the one or more computing devices of the computer system 110 may each include a processor 112, a memory 114, a signal expansion subsystem 120, a feature selection subsystem 130, a model training subsystem 140, a classification subsystem 150, and/or other components. The computer system 110 may access data from and store data to a training database 141 and a model database 151.

The training database 141 may include a corpus of transfer records. Each transfer record in the training database 141 may include transactional data from previous A2A transfers whose outcomes are known. For example, each transfer record may include a sender identifier, sender details, a sender account identifier, a receiver identifier, receiver details, a receiver account identifier, a transfer amount, a transfer date, and/or other data know about the A2A transfer. In some examples, each transfer record may be stored in association in the training database 141 with a corresponding label. The label may indicate a result of the A2A transfer, such as approved, declined, or other result. These labelled transfer records 143A-N may be used to train the trust classification model 152. The model database 151 may store model features, learned model parameters (such as tree structures, leaf weights, and boosting data), hyperparameters used, and/or other data related to training or executing the trust classification model 152.

The processor 112 may be a semiconductor-based microprocessor, a central processing unit (CPU), an application specific integrated circuit (ASIC), a field-programmable gate array (FPGA), and/or other suitable hardware device. Although the computer system 110 has been depicted as including a single processor 112, it should be understood that the computer system 110 may include multiple processors, multiple cores, or the like. The memory 114 may be an electronic, magnetic, optical, or other physical storage device that includes or stores executable instructions. The memory 114 may be, for example, Random Access memory (RAM), an Electrically Erasable Programmable Read-Only Memory (EEPROM), a storage device, an optical disc, and the like. The memory 114 may be a non-transitory machine-readable storage medium, where the term “non-transitory” does not encompass transitory propagating signals. The signal expansion subsystem 120, the feature selection subsystem 130, the model training subsystem 140, and the classification subsystem 150 may each be implemented as instructions that program the processor 112. Alternatively, or additionally, the signal expansion subsystem 120, the feature selection subsystem 130, the model training subsystem 140, and the classification subsystem 150 may each be implemented in hardware.

The signal expansion subsystem 120 may expand sparse data signals to generate an expanded set of signals using data from one or more data sources 101. The feature selection subsystem 130 may generate features from the expanded set of signals, generate feature vectors for training the trust classification model 152 and then select the top performing features. It should be noted that users may select the top performing features and the signal expansion subsystem 120 may access these selected features for training models. The model training subsystem 140 may train the trust classification model 152 using the top performing features (and their corresponding feature vectors). The classification subsystem 150 may execute the trust classification model 152 to classify A2A transfer.

### Signal Expansion, Feature Generation and Selection, and Model Training

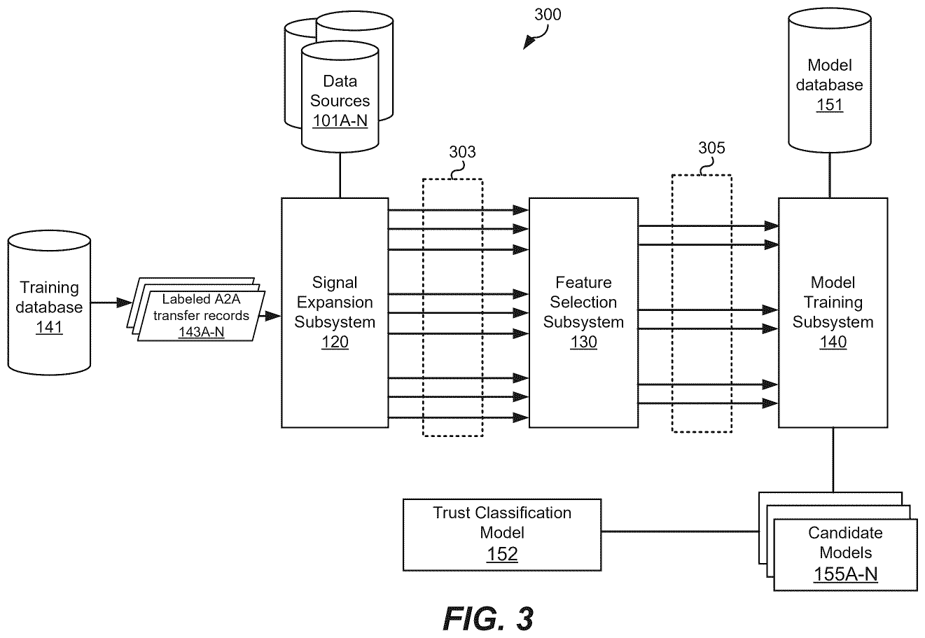

FIG. 3 illustrates a data flow 300 of an example of signal expansion, feature selection, and training the trust classification model 152 in the system environment 100. The signal expansion subsystem 120 may access training data from the training database 141. For example, the signal expansion subsystem 120 may access labelled transfer records 143A-N. The signal expansion subsystem 120 may expand upon sparse signals, from each labelled transfer record 143, to generate an expansion signal set 303 for the corresponding labelled transfer record 143.

### Expansion Signal Sets

An expansion signal set 303 is a plurality of signals generated from a set of sparse signals. The number of sparse signals that can be used for training the trust classification model 152 is less than the number of signals in the expansion signal set 303 that can be used for training. For example, a sparse signal may be usable for training and may be combined with other data (such as data from the one or more data sources 101 and/or another sparse signal) to generate two or more signals that are usable for training. In another example, a sparse signal may, by itself, not be usable for training but, when combined with other data (such as data from the one or more data sources 101 and/or another sparse signal), generates one or more signals that are usable for training. Examples of these types of signal expansion will be described with respect to different types of expanded signals in the expansion signal set 303. For example, the expansion signal set 303 may include one or more identity verification signals, one or more relationship history signals, one or more network pattern signals, and/or other types of signals.

### Identity-Based Signal Expansion

Identity verification signals may be expanded from identity data that is included in a transfer record, such as a labelled transfer record 143. For example, a name and/or mailing address of a receiver in a labelled transfer record 143 may, by itself, not be useful information for training or otherwise detecting scams. However, the name and/or address of the receiver may be combined with data from the one or more data sources 101 to determine whether the name and/or address matches the data from the one or more data sources 101. For example, the name and/or address of the receiver may be known from other contexts, such as payment network data known about merchants or other entities or third party data that stores information about entities. In this example, a match or no match can be used as a signal that can be useful for training. In particular, matches may indicate less likelihood of a scam whereas non-matches may indicate more likelihood of a scam because the name and/or address could be a result of synthetic data (created for the scam).

In another example, a name and/or email address of a receiver may be expanded to generate a signal that indicates a number of different records that the name and/or email address matches. For example, if an email address of a receiver matches the record of a number of different entities in data from the one or more data sources 101, this may indicate a higher likelihood of a scam. Similarly, if a name is associated with multiple distinct email addresses in data from the one or more data sources 101, this may indicate a higher likelihood of a scam.

In another example, the frequency of the receiver's phone carrier or receiver's name in the receiver's country may be analyzed. For example, a higher frequency of the receiver's name may suggest a higher likelihood of being fake name (and therefore a scam).

### Relationship History Signals

Relationship history signals may be expanded from known associations between data elements. For example, sender and receiver location data may be expanded to determine proximity to one another. Location data may include physical addresses, IP addresses, phone number country codes, and/or other location data that may be known about the sender or receiver. In some instances, the location of a sender and/or a receiver may be extracted from a labelled transfer record 143 or may be obtained from data in the one or more data sources 101. Proximity between the sender and the receiver may help identify cross-border scams if they are in the same city/country or region.

### Network Pattern Signals

Network pattern signals may be expanded from known network data. For example, network data may indicate whether and when a receiver was first observed in the network (based on transfer records and/or data from one or more data sources 101). In particular, a sender address, sender email or sender phone number may be used to look up data in the one or more data sources 101, which may include a vast network of transactional data across different platforms to see if the address, email, or phone number was seen before. For example. If the email age is less than one month, it is considered as a potential risky transaction. Likewise, a receiver address, receiver email or receiver phone number may be used to look up data in the one or more data sources 101 see if the address, email, or phone number was seen before.

In some examples, network pattern signals may include transaction similarity signals. Different data points may be analyzed to determine the composition of a transaction to identify any patterns. For example: on the sender side, does the sender usually send money above a certain amount? How often does the sender send money using the same platform in a time period such as a month or year? What was the time gap between sender's last transaction vs. a current transaction? Does the sender usually transact at this time of the day based on their location? Does the sender send the same/similar amount range to the same receiver? Is the sender a regular user with many different receivers according to the previous transactions, or he/she uses the account only for 1-2 distinct receivers?

On the receiver side, has this receiver been recently very active such as receiving transfers from other senders? If so, how many transfers has the receiver received from other senders? Has this receiver received similar amount ranges from other senders? Is that amount unusual than the last N number times, where N is an integer? Is the receiver also a regular Sender, which may be defined as a threshold number of transfers within a specified time period?

### Feature Generation and Selection

The feature selection subsystem 130 may access data from the data sources 101, generate features based on the data, and identify features that are associated with the labels. In this way, the feature selection subsystem 130 may identify features that correlate with the labels. In other words, the feature selection subsystem 130 may identify features that likely can be used to predict whether a given input transfer record is a scam based on the labelled data.

TABLE 1
illustrates examples of signals and expanded signals that may be used
for training (and executing) the trust classification model 152.

| Signal | Expanded Signal | Feature Value |
|---|---|---|
| Name of | Matches Known Records? | Yes/No (0 or 1) |
| Receiver | Relative frequency of | Numeric value |
| | receiver's name within the | (between 0 and 1) |
| | receiver's country (in | |
| | percentage) | |
| | Number of Matches to | Integer value |
| | different Records | |
| Receiver's | Relative frequency of | Numeric value |
| phone number | receiver's phone carrier | (between 0 and 1) |
| | within the receiver's country | |
| Email Address | Matches Known Records? | Yes/No (0 or 1) |
| of Receiver | Number of Matches to | Integer value |
| | different Records | |
| Location of | Proximity between Sender | Yes/No (0 or 1) |
| Sender and | and Receiver - Are Sender | |
| Receiver | and Receiver within the same | |
| | region or threshold distance | |
| Location of | Distance between Sender and | Distance metric such |
| Sender and | Receiver | as number of miles. |
| Receiver | | |
| Sender email, | Seen before? | Length of time since |
| address, or | | first or last seen |
| phone number | | |
| Receiver email, | Seen before? | Length of time since |
| address, or | | first or last seen |
| phone number | | |
| Sender transfer | How often does the sender | Yes/No (0 or 1) |
| data | send money using the same | |
| | platform in a time period such | |
| | as a month or year? | |
| | What was the time gap | Yes/No (0 or 1) |
| | between sender's last | |
| | transaction vs. a current | |
| | transaction? | |
| | Does the sender usually | Yes/No (0 or 1) |
| | transact at this time of the day | |
| | based on their location? | |
| | Does the sender send the | Yes/No (0 or 1) |
| | same/similar amount range to | |
| | the same receiver? | |
| | Is the sender a regular user | Yes/No (0 or 1) |
| | with many different receivers | |
| | according to the previous | |
| | transactions, or he/she uses | |
| | the account only for 1-2 | |
| | distinct receivers? | |
| Receiver | Has this receiver been recently | Yes/No (0 or 1) |
| transfer | very active such as receiving | |
| data | transfers from other senders? | |
| | How many transfers has the | Integer value |
| | receiver received from other | |
| | senders? | |
| | Has this receiver received | Yes/No (0 or 1) |
| | similar amount ranges from | |
| | other senders? | |
| | Is that amount unusual than | Yes/No (0 or 1) |
| | the last N number times, | |
| | where N is an integer? | |
| | Is the receiver also a regular | Yes/No (0 or 1) |
| | Sender? | |
| | Number of times that the | Integer value |
| | receiver sent a transfer | |

### Feature Selection

The feature selection subsystem 130 may generate features from the expansion signal set 303. To illustrate, for each expanded symbol in Table 1, the feature selection subsystem 130 may generate a feature using a corresponding feature value. The feature selection subsystem 130 may vectorize features for training candidate models 155A-N. A feature vector is a list of numbers, where each number (called a component) corresponds to a specific feature or attribute of the data such as a feature value of a feature in Table 1. The length of the list determines the dimensionality of the vector. A feature vector with two numbers is two-dimensional (2D), three numbers is three-dimensional (3D), and so on. Vectors represent data numerically and may transform complex data into a format that machines can understand for training models. In some examples, vectors may encode relationships through vector positions and distances in a high-dimensional space. Similarities and patterns between data points may be determined based on their respective positions in the high-dimensional space relative to one another.

The feature selection subsystem 130 may test each of the expanded signals 303 and their corresponding derived feature vectors for their performance (such as Area Under Curve (AUC) for model-dependent selection) and information value against detecting A2A transfer scams. The best performing signals are then selected and vectorized to generate feature vectors 305. The feature vectors 305 corresponding to the selected features derived from best performing expanded signals 303 are fed into candidate machine learning models that are trained using labelled data for fine tuning. Hyperparameter tuning may be made on the selected features in order to prevent any overfitting in the models.

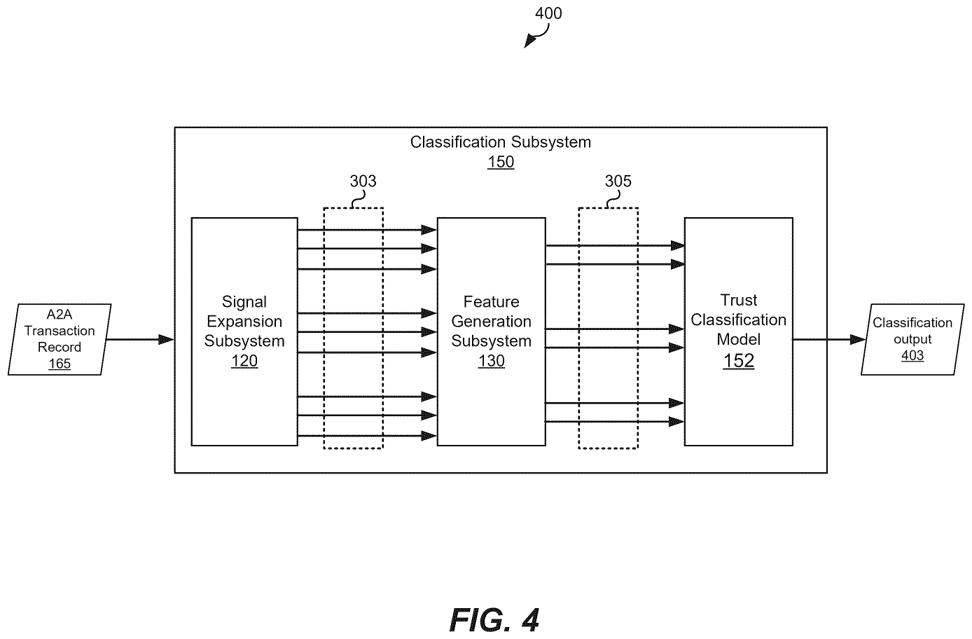

The model training subsystem 140 may train a plurality of candidate models based on respective sets of features and/or parameters such as hyperparameters. The candidate models may then be evaluated according to various model performance criteria and the trust classification model 152 (and corresponding features and/or parameters) may be selected from among one or more top N performing candidate models for classifying A2A transfers. The output of a selected trust classification model 152 may be a trust score that can be used by sender FIs 160 to determine whether the transaction should be processed or blocked for review/further verification, as will be described with respect to FIG. 4.

The model training subsystem 140 may train different RCs based on the selected features and hyperparameters. The hyperparameter values may be tuned by optimizing according to performance based on model performance metrics such as ByBatch AUC.

Highest ByBatch AUC is the highest performance observed within specific batches or subsets of the data. By analyzing the AUC on a per-batch basis, particular segments or subsets of the data for which the model is performing relatively worse compared to others may be identified. This insight can be valuable for identifying patterns or issues within the data or the model itself, allowing for targeted improvements or adjustments.

TABLE 2
illustrates an example of a set of tuned
training parameters for XGBoost:

“training”: {
“workers”: 24,
“rounds”: 400,
“xgBoostParams”: {
“trainTestRatio”: 0.95,
“eta”: 0.11,
“maxDepth”: 4,
“scalePosWeight”: 9,
“gamma”: 3,
“minChildWeight”: 1000,
“maxDeltaStep”: 0,
“subsample”: 0.65,
“colsampleBytree”: 0.5,
“colsampleBylevel”: 1,
“lambda”: 0,
“alpha”: 0.11,
“objective”: “binary:logistic”,
“evalMetric”: “auc”,
“treeMethod”: “approx”,
“sketchEps”: 0.03
}

### Training Parameters

Workers: This parameter typically refers to the number of parallel threads or processes used during training. In this case, it's set to 24, meaning that the training process will utilize 24 workers to expedite the training process.
Rounds: This specifies the number of boosting rounds or iterations during the training process. In this example, the number of rounds is set to 400, meaning the algorithm will go through the training data four hundred times to iteratively improve the model. For example, if set to 400, the algorithm may train 400 trees.
The “xgBoostParams” section shows specific parameters for Extreme Gradient Boosting (XGBoost) training.
trainTestRatio: This parameter indicates the ratio of training data to testing data. A value of 0.95 suggests that 95% of the data will be used for training and 5% for testing.
eta: Also known as learning rate, it controls the step size at each iteration while moving toward a minimum of the loss function. A lower value usually means slower learning but potentially better convergence.
maxDepth: This parameter defines the maximum depth of a tree. A depth of 4 means each tree can have a maximum of 4 levels.
scalePosWeight: This is a parameter to control the balance of positive and negative weights, set to 9, which may mitigate imbalanced classes.
gamma: Regularization parameter. It encourages pruning of the tree by penalizing the number of additional splits. A higher value means more regularization.
minChildWeight: Minimum sum of instance weight (hessian) needed in a child. Used to control over-fitting. A higher value means more conservative, avoiding splitting when the sum of the instance weight is below this value.
maxDeltaStep: Maximum delta step each tree's weight estimation is allowed to be. It helps
make the update step more conservative.
subsample: Subsample ratio of the training instance. This is the ratio of the training data to be used for each boosting round. Smaller values make the algorithm more conservative and prevent overfitting.
colsampleBytree: Subsample ratio of columns (features) when constructing each tree.
colsampleBylevel: Subsample ratio of columns for each level.
lambda: L2 regularization term on weights. Increasing this value will make a model more conservative.
alpha: L1 regularization term on weights. Increasing this value will make a model more conservative.
objective: The learning objective, which is set to “binary: logistic” which means XGBoost will be used for binary classification and output probabilities.
evalMetric: The evaluation metric to be used, which is set to “auc” which stands for Area Under the Curve. It's often used for binary classification problems to evaluate the model's performance.
treeMethod: The method to use for tree construction, which is set to “approx” which indicates approximate greedy algorithm.
sketchEps: Parameter for approximate greedy algorithm.

The model training subsystem 140 may train the trust classification model 152 (or RC models that are evaluated, selected and then used as a trust classification model 152) using an eXtreme Gradient Boosting (XGBoost). Gradient boosting is a machine learning technique for regression and classification problems, which produces a prediction model in the form of an ensemble of weak prediction models, typically decision trees. Gradient boosting may build a model in a stage-wise fashion and generalizes the model by allowing optimization of an arbitrary differentiable loss function. Gradient boosting may operate on categories/sub-categories of features, making it suited for the features described herein. XGBoost is an ensemble learning algorithm, in which predictions of multiple models are combined to create a more robust and accurate final prediction. These individual models are often called “weak learners”. XGBoost builds an ensemble of models in a step-by-step manner. At each step, it focuses on correcting the errors made by the previous models. XGBoost may use gradient descent to optimize the performance during training.

During training, in some examples, XGBoost learns to map feature vectors to a probability of risk by constructing an ensemble of decision trees. In the transaction examples, the output may be a probability of fraud (probability that the email address or other signal is associated with fraud). XGBoost builds an ensemble of decision trees sequentially. Each tree is trained to correct the errors of the previous one. Decision trees are a set of rules that split the data based on feature values (such as those listed in Table 1) to make predictions. XGBoost employs gradient boosting, which means each tree is trained to minimize the residual errors (the differences between predicted and actual values) from the previous tree.

XGBoost optimizes a predefined objective function during training. For classification tasks, the objective function typically measures the difference between predicted and actual class labels, such as labels that indicate riskiness (levels of risk). For example, the objective function aims to minimize the errors in predicting the riskiness of email addresses based on the provided features. XGBoost selects the best feature and split point at each node of the decision trees to maximize the reduction in the objective function. For example, XGBoost would evaluate different split points for features such as the features derived from the expansion signal set 303.

XGBoost includes regularization techniques to prevent overfitting, which occurs when the model learns to memorize the training data rather than generalize to unseen data. Regularization parameters control the complexity of the decision trees and penalize large coefficients, helping to ensure a more robust and generalizable model. XGBoost employs tree pruning techniques to remove unnecessary branches of the decision trees, reducing their complexity and preventing overfitting. Pruning ensures that the ensemble of trees remains interpretable and efficient while maintaining high predictive performance. XGBoost updates the model's parameters (weights or coefficients) using gradient descent optimization. It calculates the gradients of the objective function with respect to the model's predictions and adjusts the model's parameters in the direction that minimizes the objective function.

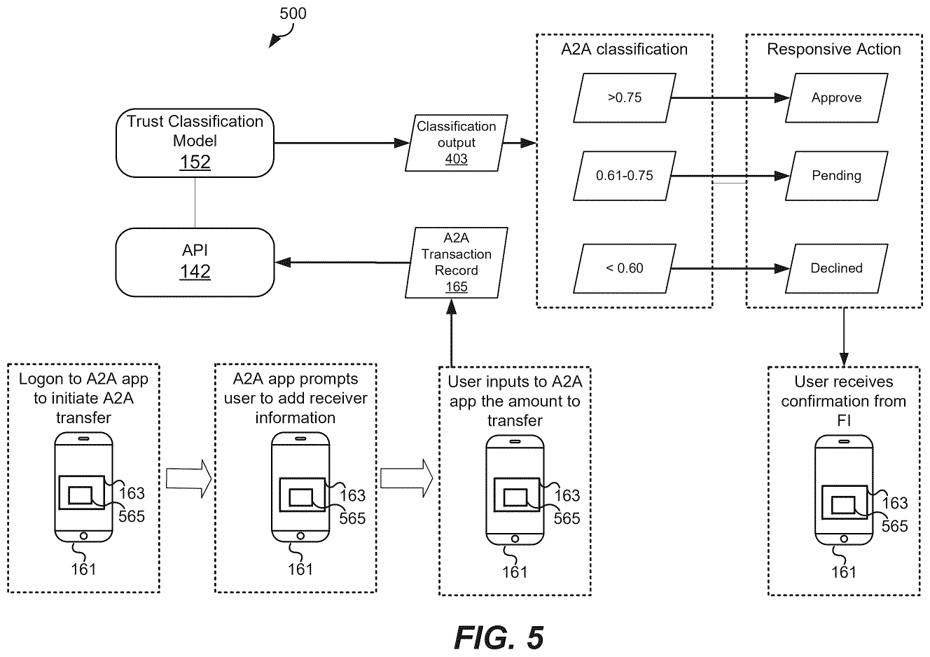

FIG. 4 illustrates a data flow 400 of an example of signal expansion and feature selection for classifying an A2A transfer based on the trained trust classification model 152. The classification subsystem 150 may access a transfer record 165. The classification subsystem 150 may generate, using the signal expansion subsystem 120, an expansion signal set 303 from the transfer record 165. The classification subsystem 150 may generate feature vectors 305 based on the expansion signal set 303 derived from the transfer record 165. The classification subsystem 150 may execute the trust classification model 152. For example, the classification subsystem 150 may provide, as input, the feature vectors 305 to the trust classification model 152. The trust classification model 152 may generate a classification output 403. The classification output 403 may be a score that represents a probability that the A2A transfer corresponding to the transfer record 165 is a scam. In some examples, the classification output 403 is a value between 0 and 1, in which 0 represents no probability of a legitimate transfer (low trust, is a scam) and 1 represents 100% probability of a legitimate transfer (high trust, not a scam). Other values may be used as well or instead. In some examples, the classification output 403 may be mapped to a responsive action, as illustrated in FIG. 5. Having described a data flow for classifying a transfer record 165, an example flow in the context of an A2A transfer request will be described.

For example, FIG. 5 illustrates an example of a data flow 500 of an A2A transfer with injection code 565 for trust classification to detect scam transfers for termination. The receiver may ask a sender to transfer funds via an A2A transfer. The request may be legitimate or could be a scam. In either instance, the sender trusts the receiver. The sender may use a sender device 161 (such as a mobile phone of the sender) to launch an A2A application 163, which may be provided by and communicate with a sender financial institution (FI) 160. The A2A application 163 may prompt the sender to input the receiver's information, such as information that identifies the receiver. The receiver information can be an email address, phone number, and/or other information that can identify the receiver. The A2A application 163 may prompt the sender to input a transfer amount.

The A2A application 163 may generate a transfer record 165 based on the receiver information, the transfer amount, and sender information. The sender information may include sender identifying data such as an account number, a name, a phone number, an email address, and/or other information that can identify the sender or sender's account at the sender FI 160.

The A2A application 163 may include injection code 565. The injection code 565 may be code that is added to the A2A application 163. For example, the injection code 565 may include an API call to the API 142. In effect, the injection code 565 intercepts A2A transfer processing in order to request classification of the A2A transfer before sending the request to the sender FI 160.

In particular, instead of transmitting a request to process the A2A transaction, the sender device 161 may execute the injection code 565, which includes an API call to the API 142 of the computer system 110. The API call may include a request to classify the transfer record 165. The API 142 may transmit the transfer record 165 to the classification subsystem 150, which generates the classification output 403, as described in FIG. 4. The classification subsystem 150 may return the classification output 403 to the API 142, which, in response to the request from the injection code 565, transmits the classification output 403 and/or the A2A classification to the sender FI 160.

The injection code 565 and/or the sender FI 160 may categorize the classification output 403 into an A2A classification corresponding to a responsive action. For instance, a classification output 403 may be placed into an A2A classification based on ranges associated with each classification. For example, each A2A classification may be associated with a respective range of values. In one example, the ranges may be: <0.60; 0.60-0.75; and >0.75. Other ranges and number of ranges/A2A classifications may be used. The particular ranges and number of ranges may be configured according to particular needs by the operator or user of the system. Each A2A classification may be associated with a corresponding responsive action. For instance, the highest range (high probability of trust/low probability of scam) may be associated with an “approval” responsive action, the middle range (moderate probability of trust/moderate probability of scam) may be associated with a “pending further investigation” responsive action, and the lowest range (low probability of trust/high probability of scam) may be associated with a “decline” responsive action. Other numbers and types of responsive actions may be used.

It should be noted that the classification subsystem 150 may use the classification output 403 to identify the appropriate range and corresponding responsive action to take. In this example, the classification subsystem 150 may transmit the responsive action to take back to the injection code 565 and/or the sender FI 160. Furthermore, in some examples, the sender FI 160 may execute the classification subsystem 150 and take appropriate responsive action. In yet further examples, the classification subsystem 150 may return the classification output 403 (score) rather than the ranges or responsive action to take.

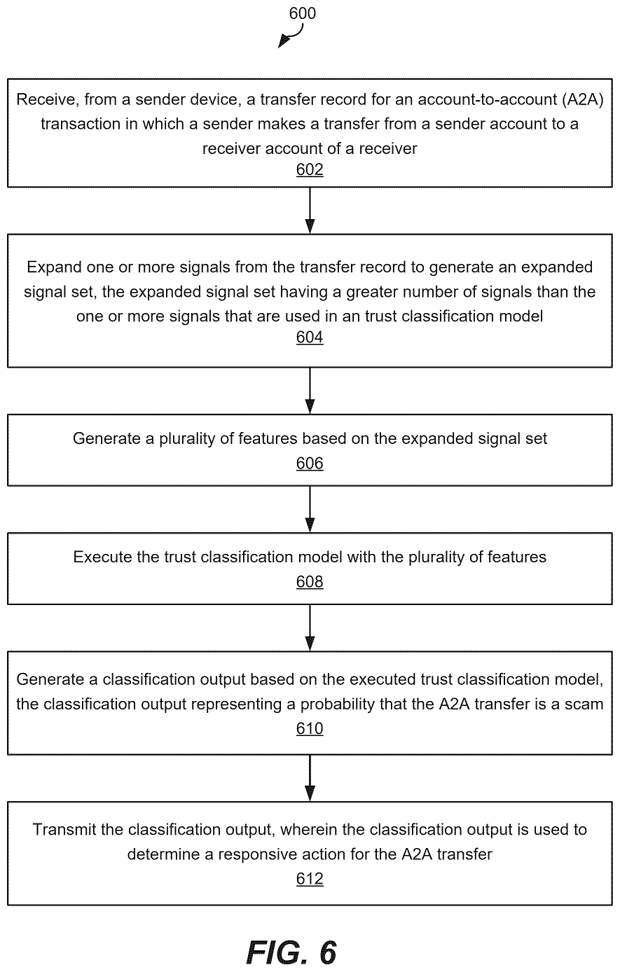

FIG. 6 illustrates an example of a method 600 for classifying an A2A transfer and terminating the transaction if classified as a scam.

At 602, the method 600 may include receiving, from a sender device (such as sender device 161), a transfer record (such as a transfer record 165) for an account-to-account (A2A) transaction in which a sender makes a transfer from a sender account to a receiver account of a receiver.

At 604, the method 600 may include expanding one or more signals from the transfer record to generate an expansion signal set (such as expansion signal set 303), the expansion signal set having a greater number of signals than the one or more signals that are used in a trust classification model (such as the trust classification model 152).

At 606, the method 600 may include generating a plurality of features (such as features used to generate feature vectors 305) based on the expansion signal set.

At 608, the method 600 may include executing the trust classification model with the plurality of features, the trust classification model having been trained to generate a prediction of whether the A2A transfer is associated with a scam by the receiver on the sender.

At 610, the method 600 may include generating a classification output (such as classification output 403) based on the executed trust classification model, the classification output representing a probability that the A2A transfer is a scam.

At 612, the method 600 may include transmitting the classification output, wherein the classification output is used to determine a responsive action for the A2A transfer.

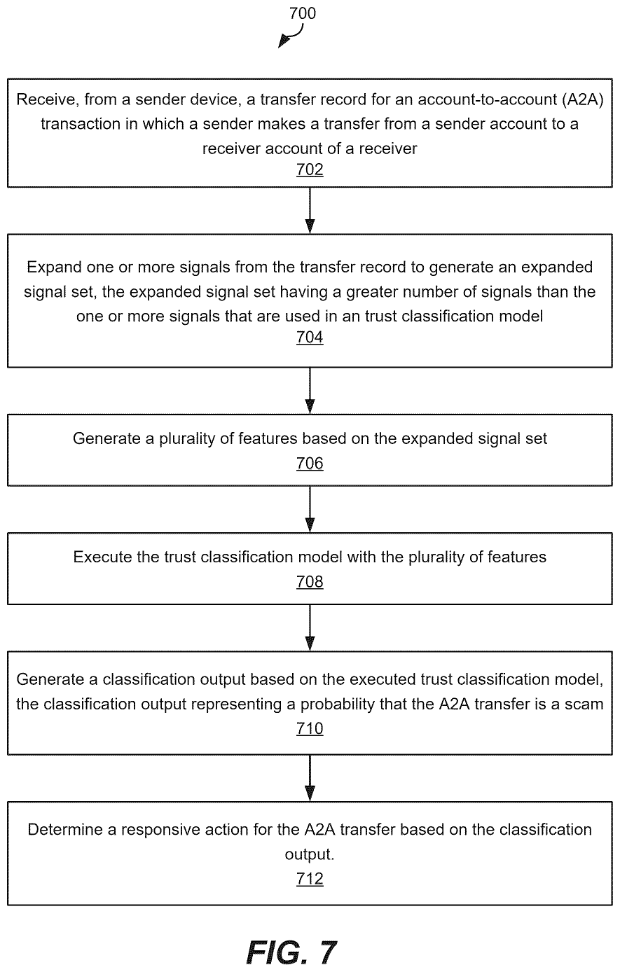

FIG. 7 illustrates another example of a method 700 for classifying an A2A transfer and terminating the transaction if classified as a scam.

At 702, the method 700 may include receiving, from a sender device (such as sender device 161), a transfer record (such as a transfer record 165) for an account-to-account (A2A) transaction in which a sender makes a transfer from a sender account to a receiver account of a receiver.

At 704, the method 700 may include expanding one or more signals from the transfer record to generate an expansion signal set (such as expansion signal set 303), the expansion signal set having a greater number of signals than the one or more signals that are used in a trust classification model (such as the trust classification model 152).

At 706, the method 700 may include generating a plurality of features (such as features used to generate feature vectors 305) based on the expansion signal set.

At 708, the method 700 may include executing the trust classification model with the plurality of features, the trust classification model having been trained to generate a prediction of whether the A2A transfer is associated with a scam by the receiver on the sender.

At 710, the method 700 may include generating a classification output (such as classification output 403) based on the executed trust classification model, the classification output representing a probability that the A2A transfer is a scam.

At 712, the method 700 may include determining a responsive action for the A2A transfer based on the classification output.

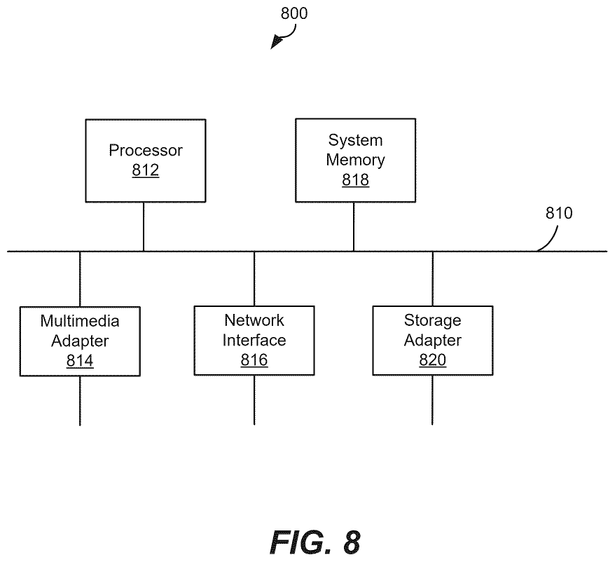

FIG. 8 illustrates an example of a computer system 800 that may be implemented by devices illustrated in FIG. 1. The computer system 800 may be part of or include the system environment 100 to perform the functions and features described herein. For example, various ones of the devices of system environment 100 may be implemented based on some or all of the computer system 800. The computer system 800 may include, among other things, an interconnect 810, a processor 812, a multimedia adapter 814, a network interface 816, a system memory 818, and a storage adapter 820.

The interconnect 810 may interconnect various subsystems, elements, and/or components of the computer system 800. As shown, the interconnect 810 may be an abstraction that may represent any one or more separate physical buses, point-to-point connections, or both, connected by appropriate bridges, adapters, or controllers. In some examples, the interconnect 810 may include a system bus, a peripheral component interconnect (PCI) bus or PCI-Express bus, a HyperTransport or industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 810 may allow data communication between the processor 812 and system memory 818, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 812 may control operations of the computer system 800. In some examples, the processor 812 may do so by executing instructions such as software or firmware stored in system memory 818 or other data via the storage adapter 820. In some examples, the processor 812 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 814 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 816 may provide the computer system 800 with an ability to communicate with a variety of remote devices over a network. The network interface 816 may include, for example, an Ethernet adapter, a Fibre Channel adapter, and/or other wired- or wireless-enabled adapter. The network interface 816 may provide a direct or indirect connection from one network element to another, and facilitate communication to and between various network elements. The storage adapter 820 may connect to a standard computer readable medium for storage and/or retrieval of information, such as a fixed disk drive (internal or external).

Other devices, components, elements, or subsystems (not illustrated) may be connected in a similar manner to the interconnect 810 or via a network. The devices and subsystems can be interconnected in different ways from that shown in FIG. 6. Instructions to implement various examples and implementations described herein may be stored in computer-readable storage media such as one or more of system memory 818 or other storage. Instructions to implement the present disclosure may also be received via one or more interfaces and stored in memory. The operating system provided on computer system 800 may be MS-DOS®, MS-WINDOWS®, OS/2®, OS X®, IOS®, ANDROID®, UNIX®, Linux®, or another operating system.

“Artificial intelligence” refers to is a branch of computer science focused on training computer models via machine learning techniques to perform tasks, such as email address classification, scam detection, and/or other classifications described herein. Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “101A-N” does not refer to a particular number of instances of 101A-N, but rather “two or more.”

The databases (such as the training database 141 and the model database 151, which may store model features, parameters, hyperparameters, and/or other data related to training or executing the trust classification model 152) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independently and separate from other components and processes described herein. Each component and process may also be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a processor programmed to:
receive, from a sender device, a transfer record for an account-to-account (A2A) transaction in which a sender makes a transfer from a sender account to a receiver account of a receiver;
expand one or more signals from the transfer record to generate an expansion signal set, the expansion signal set having a greater number of signals than the one or more signals that are used in a trust classification model;
generate a plurality of features based on the expansion signal set;
execute the trust classification model with the plurality of features, the trust classification model having been trained to generate a prediction of whether the A2A transfer is associated with a scam by the receiver on the sender;
generate a classification output based on the executed trust classification model, the classification output representing a probability that the A2A transfer is a scam; and
transmit the classification output, wherein the classification output is used to determine a responsive action for the A2A transfer.

2. The system of claim 1, wherein to expand the one or more signals, the processor is programmed to execute identity-based signal expansion in which identifying information of a sender or receiver is used to generate a feature that is based on a number of times that the identifying information matches secondary data.

3. The system of claim 1, wherein to expand the one or more signals, the processor is programmed to execute relationship history signal expansion in which a relationship between the sender and the receiver is used to generate a feature.

4. The system of claim 1, wherein to expand the one or more signals, the processor is programmed to execute network pattern signal expansion in which network activity of the sender or receiver is used to generate a feature.

5. The system of claim 1, wherein to expand the one or more signals, the processor is further programmed to:
identify secondary data based on the one or more signals, the secondary data not present in the transfer record; and
generate a feature, from among the plurality of features, based on the secondary data.

6. The system of claim 5, wherein the secondary data comprises identifying data of the receiver in one or more data sources other than the transfer record, and wherein at least one expanded signal is based on a number of times the receiver identified in the transfer record matches the secondary data.

7. The system of claim 5, wherein the secondary data comprises a network pattern signal associated with the receiver, the network pattern signal indicating a length of time in which an email or phone number of the receiver was first or last seen by the system.

8. The system of claim 5, wherein the secondary data comprises sending activity of the sender, and wherein at least one expanded signal is based on a number of times or frequency in which the sender transferred via A2A transfers.

9. The system of claim 5, wherein the secondary data comprises sending activity of the sender, and wherein at least one expanded signal is based on an amount of one or more prior A2A transfers made by the sender.

10. The system of claim 5, wherein the secondary data comprises receiving activity of the receiver, and wherein at least one expanded signal is based on the receiving activity of the receiver.

11. The system of claim 1, wherein the one or more signals comprise location data of the sender and location data of the receiver, and wherein the processor is programmed to:
determine a proximity or distance between the sender and the receiver; and
generate a feature based on the proximity or distance.

12. The system of claim 1, wherein the processor is further programmed to:
receive the transfer record based on an API call injected into an A2A application of the sender device.

13. A method, comprising:
receiving, from a sender device, a transfer record for an account-to-account (A2A) transaction in which a sender makes a transfer from a sender account to a receiver account of a receiver;
expanding one or more signals from the transfer record to generate an expansion signal set, the expansion signal set having a greater number of signals than the one or more signals that are used in a trust classification model;
generating a plurality of features based on the expansion signal set;
executing the trust classification model with the plurality of features, the trust classification model having been trained to generate a prediction of whether the A2A transfer is associated with a scam by the receiver on the sender;
generating a classification output based on the executed trust classification model, the classification output representing a probability that the A2A transfer is a scam; and
transmitting the classification output, wherein the classification output is used to determine a responsive action for the A2A transfer.

14. The method of claim 13, wherein expanding the one or more signals comprises:
executing identity-based signal expansion in which identifying information of a sender or receiver is used to generate a feature that is based on a number of times that the identifying information matches secondary data.

15. The method of claim 13, wherein expanding the one or more signals comprises:
executing relationship history signal expansion in which a relationship between the sender and the receiver is used to generate a feature.

16. The method of claim 13, wherein expanding the one or more signals comprises:
executing network pattern signal expansion in which network activity of the sender or receiver is used to generate a feature.

17. The method of claim 13, wherein the one or more signals comprise location data of the sender and location data of the receiver, the method further comprising:
determining a proximity or distance between the sender and the receiver; and
generating a feature based on the proximity or distance.

18. The method of claim 13, further comprising:
receiving the transfer record based on an API call injected into an A2A application of the sender device.

19. A non-tangible computer-readable medium storing instructions, the instructions, when executed by a processor, programs the processor to:
receive, from a sender device, a transfer record for an account-to-account (A2A) transaction in which a sender makes a transfer from a sender account to a receiver account of a receiver;
expand one or more signals from the transfer record to generate an expansion signal set, the expansion signal set having a greater number of signals than the one or more signals that are used in a trust classification model;
generate a plurality of features based on the expansion signal set;
execute the trust classification model with the plurality of features, the trust classification model having been trained to generate a prediction of whether the A2A transfer is associated with a scam by the receiver on the sender;
generate a classification output based on the executed trust classification model, the classification output representing a probability that the A2A transfer is a scam; and
determine a responsive action for the A2A transfer based on the classification output.

20. The non-tangible computer-readable medium of claim 19, wherein to determine the responsive action, the instructions when executed by the processor further program the processor to:
determine that the A2A transfer is likely a scam based on the classification output; and
decline the A2A transfer.
